(19) United States
(12) Patent Application Publication
(10) Pub. No.: US 2010/0035590 A1
(43) Pub. Date: Feb. 11, 2010

(54) METHOD OF OBTAINING DIRECTORY NUMBER

(75) Inventor: Paul Maxwell Martin, Hampshire (GB)

Correspondence Address: NIXON PEABODY, LLP, 401 9TH STREET, NW, SUITE 900, WASHINGTON, DC, 20004-2128, US

(73) Assignee: M.M.I. RESEARCH LIMITED, Hartley Wintney, Hampshire (GB)

(21) Appl. No.: 12/527,728

(22) PCT Filed: Feb. 15, 2008
(86) PCT No.: PCT/GB08/00531

§ 371 Date: Sep. 29, 2009

(30) Foreign Application Priority Data
Feb. 26, 2007 (GB) 0703701.3

(51) Int. Cl. H04L 29/06

(52) U.S. Cl. 455/414.3

(57) ABSTRACT

A method of obtaining the directory number (such as the MSISDN) of a mobile device registered with a mobile communication network. The method comprises: causing the mobile device to disconnect from the network and connect with a separately introduced transmitter which is not under the control of the network; sending a request to the mobile device from the separately introduced transmitter, the request including an identification of a convenient device, and causing the mobile device to transmit a response to the network, which in turn causes the network to retrieve the directory number of the mobile device from a database and transmit it to the convenient device; and receiving the directory number from the network at the convenient device.

### FIELD OF THE INVENTION

The present invention relates to a method of obtaining the directory number, such as the Mobile Station International Subscriber Directory Number (MSISDN), of a mobile device registered with a mobile communication network.

### BACKGROUND OF THE INVENTION

Various methods of implementing a separately introduced transmitter (which emulates a Base Station or NodeB of a 2G or 3G network) are described in WO 2007/010223. These methods enable the acquisition of the International Mobile Subscriber Identity (IMSI) Temporary Mobile Subscriber Identity (TMSI) and International Mobile Equipment Identity (IMEI) of a mobile device. It is desirable to obtain the directory number of a mobile device using such a separately introduced transmitter. However, operators of such devices conventionally do not have straightforward access to the directory number.

### SUMMARY OF THE INVENTION

A first aspect of the invention provides a method of obtaining the directory number of a mobile device registered with a mobile communication network, the method comprising:
causing the mobile device to disconnect from the network and connect with a separately introduced transmitter which is not under the control of the network; and
sending a request to the mobile device from the separately introduced transmitter, the request including an identification of a convenient device, and causing the mobile device to transmit a response to the network, which in turn causes the network to retrieve the directory number of the mobile device from a database and transmit it to the convenient device.

A second aspect of the invention provides a method of providing the directory number of a mobile device registered with a mobile communication network, the method comprising:
disconnecting the mobile device from the network and connecting the mobile device with a separately introduced transmitter which is not under the control of the network;
receiving a request at the mobile device from the separately introduced transmitter, the request including an identification of a convenient device; and
transmitting a response to the network, which in turn causes the network to retrieve the directory number of the mobile device and transmit it to the convenient device.

If the network is a GSM or WCDMA 3G network, then the directory number is typically a Mobile Station International Subscriber Directory Number (MSISDN). However, the invention is not limited to use in such networks. For example if the network is a 3GPP2 CDMA2000 network then the director number may be either an MSISDN or an alternate directory number such as a Mobile Directory Number (MDN).

Typically the request is addressed to a subscriber identifier of the mobile device (such as an IMSI or TMSI). The subscriber identifier may have been previously acquired by the separately introduced transmitter, or acquired by some other means.

Typically the request is processed at the mobile device by a removable module such as a Universal Subscribe Identity Module (USIM) if the network is a GSM or WCDMA 3G network, or a Removable User Identity Module (R-UIM) if the network is a CDMA2000 network.

Preferably the request is formatted such that the mobile device does not alert a user of the mobile device that the request has been received.

### BRIEF DESCRIPTION OF THE DRAWING

Embodiments of the invention will now be described with reference to the accompanying drawing, which shows a SIMBTS, a target MS, and a GSM network.

### DETAILED DESCRIPTION OF EMBODIMENT(S)

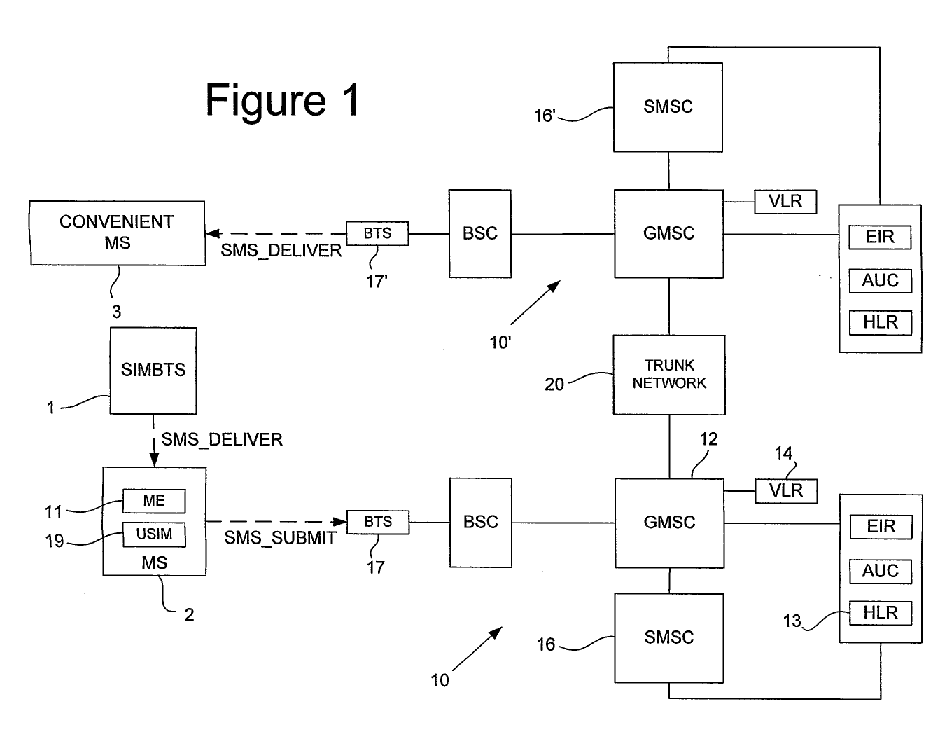

FIG. 1 shows a Separately Introduced Mobile Base Station (SIMBTS) 1, and a target mobile station (MS) 2 registered with a GSM network 10. The MS 2 comprises a Mobile Equipment (ME) 11, and a removable Universal Subscriber Identity Module (USIM) 19. The SIMBTS 1 is configured to acquire identity parameters such as the IMSI, IMEI and TMSI via a wireless link with the MS 2. This is achieved by emulating a BTS of the network 10 using a method specially adapted to the GSM protocol, as described in further detail in WO 2007/010223.

The SIMBTS 1 is typically a mobile device, which may be housed in a vehicle. In use, the SIMBTS 1 is moved to an area, and operated to acquire identity parameters from a set of MSs registered with the network 10 in that area. Alternatively the SIMBTS 1 may be permanently located in an area of interest. In both cases, the SIMBTS 1 effectively transmits a false cell broadcast which is not under the control of the network 10.

A key issue with the conventional SIMBTS described in WO 2007/010223 is that whilst it can acquire IMSIs, IMEIs and TMSIs, it cannot normally acquire the mobile telephone number (correctly the MSISDN number) of the target MS 2. The reason for this is that the network 10 is designed to prevent this number being transmitted over the air. When a call is routed, the number is located by a Gateway Multimedia Switching Centre (GMSC) 12 when routing the call to its destination. The GMSC 12 obtains the number by performing a database lookup on a Home Location Register (HLR) 13, using the IMSI as the key in a database lookup.

The SIMBTS 1 is configured to obtain the MSISDN of the target MS 2 by a method involving the use of SMS messages and USIM cards. Before describing the method, some background information on SMS messages and USIM cards will be provided.

### SMS Messages

The content of SMS messages consists of two principle elements:
1 Protocol fields associated with different network equipments such as the messaging centres, known as Short/Multimedia Message Service Centre (SMSC/MMSCs) and their peers in other networks, together with 2G and 3G air interface control protocol headers.
2 Transported data which has a variety of applications depending on the destination of the data. This can include basic text through to phone-based software applications where the SMS is a data transport channel. Of particular note is the ability for network operators to download software configuration parameters to the USIM card in the handset. This uses a feature on the USIM called the USIM Application Toolkit (SAT) to which there is a peer software application used by the network operator and often supplied by the USIM manufacturer e.g. Gemplus SIM Toolkit (see http://www.gemplus.com/techno/stk/).

This can be extended to Multimedia messaging (MMS)

### USIM Cards

One of the primary functions of a USIM card is to process the authentication and ciphering elements of a GSM or 3G network. As such, it carries the IMSI identity in encrypted form.

### Method of Obtaining MSISDN

A method of obtaining the MSISDN of the target MS 2 will now be described. This technique allows the MSISDN number to be retrieved by using a combination of a SIMBTS and any convenient device, such as an MS or a wired desk phone with a calling line identification (CLI) display.

The technique involves the following steps:
1 Deploy SIMBTS 1 to a location in which the target MS 2 (containing the target ME 11 and inserted USIM 19) is present.
2 Configure the SIMBTS 1 with the MSISDN number of the Short Message Service Centre (SMSC) 16 of the network 10 and the destination MSISDN number of a convenient MS 3.
3 Cause target MS 2 to perform a location update to the SIMBTS 1, and configure the SIMBTS 1 to lock the target MS 2 to it at this point. This causes the target MS 2 to disconnect from the network 10 and connect with the SIMBTS 1 and prevents the target MS 2 from re-attaching to the network 10. For further details of the procedure see WO 2007/010223.
4 Send specially formatted SMS message to target MS 2
5 Immediately shut down transmit power on SIMBTS 1
6 Target MS 2 reconnects to its previous authentic network 10 via BTS 17
7 Target MS 2 sends an acknowledgment to the SMS sent by the SIMBTS 1, but over the authentic network 10. The SMS is routed via a Trunk Network 20 and an additional network 10′ to a convenient MS 3.
8 SMS acknowledgement arrives at the convenient MS 3. The convenient MS 3 displays the MSISDN number of the target MS 2.

In an alternative method, steps 3 and 4 are combined such that the specially formatted SMS is sent immediately the Location Update request from the target MS 2 is received by the SIMBTS 1. Then, instead of step 5, a Location Reject message is sent to the target MS 2 forcing it to reconnect with network 10 shortly after the SMS message is sent. By not shutting down the transmit power of the SIMBTS 1, this method enables the SIMBTS 1 to continue performing other functions (such as the acquisition of IMSIs, TMSIs and/or IMEIs as described in WO 2007/010223).

A key aspect of the procedure is the correct formatting of the SMS message to be sent from the SIMBTS 1 to the target MS 2 in step 4. The wanted SMS message consists of a modified encoding of a specific SAT message. The encoding ensures that the message passes from the SIMBTS 1, through the ME 11 to the USIM 19, and the USIM 19 is instructed that the message is unencrypted and not ciphered so can act on it directly.

The detail will now be described, in the following steps:
1 How to transport an SMS message from the SIMBTS 1 to the USIM 19
2 How to code the SMS message such that the USIM 19 is instructed to decode and act on the message
3 How the response is generated from the USIM 19
4 How the response is delivered

### 1 How to Transport Message

SMS messages can be sent from the network 10 to an MS or vice versa.

Network (SMSC) to MS, messages are by definition SMS_DELIVER

MS to Network, messages are by definition SMS_SUBMIT

The message formats and usage over the radio interface are defined in 3GPP specifications 23.039, 23.040 and 24.011.

The correct message format in the present case is to mimic the format of a message from a SIM Application Toolkit (SAT) application using an SMS_DELIVER message from the SIMBTS 1 to the target MS 2. The SAT is an application which can set up a communication path between the SAT and a particular USIM card. The USIM 19 has to have SIM Toolkit capabilities in order to accept the message.

Additionally the USIM 19 has to register its interest in a particular message set with the ME 11 in order for the messages to be passed to the USIM. It does so using the SET EVENT LIST command from the USIM 19 to the ME 11.

There are many possible messages that can be transmitted from the SAT to the ME 11 and hence to the USIM 19. The specific message used is a sub-class of messages that the USIM 19 informs the ME 11 that it is interested in as described above. These messages are specified in 3GPP 31.111. The specific message is the Envelope SMS-PP data download from the ME 11 to the USIM 19.

This therefore provides a transport mechanism such that a correctly formatted SMS_DELIVER message from the SIMBTS 1 can arrive at the USIM 19.

### 2 How to Code the Message

Conventionally, security is applied to the SAT messages such that the USIM has to employ special techniques to correctly decode the message. The security mechanisms are specified in ETSI TS 03.48. These are implemented using the flexible header construction of SMS messages. SMS messages contain a mandatory header which specifies various flags, protocol identifiers, timestamp etc. and importantly a User Data Header Indicator. This indicates that further instructions as to how to deal with the SMS message are included in a further User Data Header (UDH) which follows on from the mandatory header. The SMS_DELIVER message sent from the SIMBTS therefore includes the required indicator that there is a UDH. Within the UDH, there is a further indicator that the optional feature required in the transmission is SIM Toolkit Security. The values for SIM Toolkit Security means that a Command Header specific to SIM Toolkit Security follows the UDH. The Command Header is important and consists of the following fields:

| | | | Length |
|---|---|---|---|
| Field Name | Short Name | Description | (bytes) |
| Security Parameter | SPI | Type of security | 2 |
| Indicator | | imposed on data | |
| Ciphering Key | KIc | Key algorithm used | 1 |
| Identifier | | | |
| Key Identifier | KID | Key and alg. used to | 1 |
| | | compute secured data | |
| Toolkit Application | TAR | Security Port | 3 |
| reference | | | |
| Counter | CNTR | Counter | 5 |
| Padding Counter | PCNTR | Number of pads | 1 |
| Integrity values | RC/CC/DS | Checksum etc of data | Variable |

The SPI indicates what type of security has been imposed on the data. This 2 byte field is divided into a number of bit fields. In order to cause the USIM 19 to process the message without applying any decryption or deciphering, the SIMBTS 1 sets the fields to the following values:

Byte 1

| | Binary | |
|---|---|---|
| Bit number | Value | Reason |
| 0, 1 | 00 | Indicates no redundancy check, crypto checksum |
| | | or digital signature is applied |
| 2 | 0 | No ciphering is applied to the data |
| 3, 4 | 00 | No counter is available |
| 5, 6, 7 | 000 | Reserved for future use |

Byte 2

| | Binary | |
|---|---|---|
| Bit number | Value | Reason |
| 0, 1 | 01 | Proof of receipt (PoR) is required to be sent to |
| | | the sending entity |
| 2, 3 | 00 | No security is applied to the PoR response to the |
| | | sending entity |
| 4 | 0 | PoR response is not ciphered |
| 5 | 1 | PoR response shall be sent using SMS_SUBMIT |
| 6, 7 | 000 | Reserved for future use |

It is the combination of fields which cause the USIM to process the message without applying any decryption or deciphering. The important objective of this message is to force the USIM 19 to provide a response which the ME 11 then transmits as an SMS_SUBMIT message.

### 3 How the Response is Generated

From the above tables, Byte 2, bit 5 forces the USIM 19 and therefore the ME 11 to send an SMS from the MS 2 back to the network 10 using a discrete SMS_SUBMIT which is addressed to the sender of the original SMS. The original sending address is a field in the SMS_DELIVER message. The SIMBTS 1 enters the previously configured MSISDN of the convenient MS 3 into the sending address field.

In detail, the address fields in the SMS_DELIVER and SMS_SUBMIT messages are described below, where:

RPDU=Relay Protocol Data Unit (which wraps the TPDU) as defined in 3GPP specification 23.040 and
TPDU=Transfer Protocol Data Unit as defined in 3GPP specification 23.040

The original SMS_DELIVER message from the SIMBTS contains the following fields:
RPDU Originating address: —MSISDN number of SMSC 16
RPDU Destination address: —Null
TPDU Originating address: —MSISDN number of the convenient MS 3

The response in the SMS_SUBMIT message from the target MS 2 contains:
RPDU Originating address: —Null
RPDU Destination address: —MSISDN number of the SMSC 16
TPDU Originating address: —MSISDN number of the convenient MS 3

The SMS_SUBMIT message is therefore routed via the SMSC 16 specified in the RPDU to the destination convenient MS 3 specified in the TPDU.

### 4 How the Response is Delivered

The response message encapsulated in the SMS_SUBMIT is addressed to the MSISDN number of the convenient MS 3. The process must ensure that this SMS_SUBMIT message is transmitted over the network 10 and not to the SIMBTS 1. Therefore as soon as the SMS_DELIVER message has been successfully sent, then the SIMBTS 1 quickly switches off RF transmission. The target MS 2 is then forced to reacquire a valid network and, once this is achieved, the SMS_SUBMIT message containing the response is transmitted.

This message is then routed to the convenient MS 3 by a conventional SMS routing process. That is, the SMSC 16 inputs the IMSI of the target MS 2 in the Home Location Register (HLR) database 13 to determine the routing information and MSISDN for the SMS. The SMSC 16 then arranges for an SMS_DELIVER message to be routed to the convenient MS 3 via a trunk network 20 and an SMSC 16′ and BTS 17′ of a different operator's network 10′.

When the SMS arrives at the convenient MS 3, the MS 3 incorporates a Calling Line Identity (CLI) screen which displays the MSISDN number of the target MS 2 (the MSISDN being part of the SMS_DELIVER message received by the convenient MS 3).

Note that in FIG. 1 the SMS_DELIVER message is shown being delivered to the convenient MS 3 by a different network 10′ which is connected to the network 10 by a trunk network 20. For example, in the UK the network 10 may be operated by the network operator Vodafone™, and the network 10′ may be operated be operated by the network operator Orange™. However, if the convenient MS 3 is positioned close to the BTS 17, and is registered with the same network operator, then it may also be camped on that BTS 17 (and hence receive the SMS from the BTS 17 of the network 10). Also, the convenient MS 3 is shown as a separate element from the SIMBTS 1. However, the SIMBTS 1 may be configured with MS functionality so that as well as sending the SMS_SUBMIT message to the target MS 11 it also receives the SMS_RECEIVE message from the network 10 (or the network 10′).

Although the preferred embodiments describe a GSM (2G) implementation, the invention may be implemented to acquire the MSISDN of a 3G mobile device (conventionally known as a UE) either directly, or by forcing the UE to disconnect from a 3G network and connect with a 2G network.

Although the invention has been described above with reference to one or more preferred embodiments, it will be appreciated that various changes or modifications may be made without departing from the scope of the invention as defined in the appended claims.

1. A method of obtaining the directory number of a mobile device registered with a mobile communication network, the method comprising:
causing the mobile device to disconnect from the network and connect with a separately introduced transmitter which is not under the control of the network; and
sending a request to the mobile device from the separately introduced transmitter, the request including an identification of a convenient device, and causing the mobile device to transmit a response to the network, which in turn causes the network to retrieve the directory number of the mobile device from a database and transmit it to the convenient device.

2. The method of claim 1 wherein the directory number is an MSISDN.

3. The method of claim 1 wherein the request is addressed to an IMSI or TMSI of the mobile device.

4. The method of claim 1 wherein the request is addressed to a subscriber identifier, and the network retrieves the directory number of the mobile device by inputting the subscriber identifier into the database.

5. The method of claim 1 wherein the request mimics the format of a message from a SIM Application Toolkit application.

6. The method of claim 1 wherein the request includes an indicator which causes the mobile device to process the request without applying any decryption or deciphering.

7. The method of claim 1 wherein the request comprises an SMS or MMS message.

8. The method of claim 1 wherein the response comprises an SMS or MMS message.

9. The method of claim 1 wherein the request is formatted such that the mobile device does not alert a user of the mobile device that the request has been received.

10. The method of claim 1 wherein the mobile device is caused to disconnect from the network and connect with the separately introduced transmitter by performing a location update to the separately introduced transmitter.

11. The method of claim 1 wherein the request is processed at the mobile device by a removable module.

12. A separately introduced transmitter configured to obtain the directory number of a mobile device by the method of claim 1.

13. A method of providing the directory number of a mobile device registered with a mobile communication network, the method comprising:
disconnecting the mobile device from the network and connecting the mobile device with a separately introduced transmitter which is not under the control of the network;
receiving a request at the mobile device from the separately introduced transmitter, the request including an identification of a convenient device; and
transmitting a response to the network, which in turn causes the network to retrieve the directory number of the mobile device and transmit it to the convenient device.
